(19) United States
(12) Patent Application Publication
(10) Pub. No.: US 2005/0169635 A1
(43) Pub. Date: Aug. 4, 2005

(54) Method and system for free-space communication

(76) Inventors: Ehud Tirosh, Jerueslem (IL); Moshe Klein, Nahal Soreq (IL); Ilan Grobman, Lawrence, NY (US)

Correspondence Address: NATH & ASSOCIATES, 1030 15th STREET, NW, 6TH FLOOR, WASHINGTON, DC, 20005, US

(21) Appl. No.: 10/512,549

(22) PCT Filed: Apr. 24, 2003
(86) PCT No.: PCT/US03/12774

Related U.S. Application Data
(60) Provisional application No. 60/375,537, filed on Apr. 25, 2002.

(51) Int. Cl. H04B 10/00

(52) U.S. Cl. 398/130

(57) ABSTRACT

A method, device, and system for communicating data modulated on an electromagnetic signal over free space in the atmosphere includes a Far Infrared (FIR) transciever (104) having a trasmitter and a receiver. The tranmitter includes a laser source configured to generate an electromagnetic signal in the FIR range and a modulator for modulating the electromagnetic signal giving rise to modulated data. The modulated data is transmitted at high transmission rates through free space. The receiver includes a detector for receiving modulated data at the high transmission rates through free space. A Near Infrared (NIR) transceiver (105) communicates data modulated on an electromagnetic signal in the NIR over free space in the atmosphere.

### FIELD OF THE INVENTION

This invention is generally in the field of Free Space Optics (FSO) or Free Space Communication techniques.

### REFERENCES

1. Isaac I Kim, Bruce McArthur, and Eric Korevaar “Comparison of laser beam propagation at 785 nm and 1550 nm in fog and haze for optical wireless communications” p2 Optical Access Incorporated Web publication. http:/www.opticalaccess.com
2. H. Willebrand “Terrestrial Optical Communication Network of Integrated Fiber and Free-space Links Which Require No Electro-optical Conversion Between Links” U.S. Pat. No. 6,239,888 2001 column 5
3. P F Szajowsky, G Nykolak, J J Auborn, H M Presby, G E Tourgy, D Romain “High power Amplifiers Enable 1550 nm Terrestrial Free-Space Optical Links Operating @ WDM 2.5 Gb/s Data Rates.” Optical Wireless Communications JI Proceedings of SPIE Volume 3850 1999
4. Art MacCarley “Advanced Image Sensing Methods for Traffic Surveillance and Detection” California PATH research Report UCB-ITS—PRR-99-11 p 16 1999
5. B R Strickland, M J Lavan, E Woodbridge, V Chan “Effects of Fog on the Bit Error Rate of a Free-space Laser Communication system” Applied Optics 38 424-431 (1999) p 428.
6. H Willebrand and M Achour “Hybrid Wireless Optical and Radio Frequency Communication Link” WO Patent 01/52450
7. G S. Herman and N P Barnes “Method and Apparatus for Providing a Coherent Terahertz Source” U.S. Pat. No. 6,144,679 2000
8. A. Kumar et al “CO₂ laser as a possible candidate for optical transmitter in a free-space satellite-ground-satellite laser communication: a case study” Proc. SPIE Vol. 3615 pp. 287-297 (1999)
9. W. Reiland et al “Optical Intersatellite communication links: state of CO₂ laser technology” Proc. SPIE Vol. 616 (1986)
10. M. Born and E. Wolf “Principles of Optics” 5^{th} edition, Pergamon Press (1975) pp. 633-647
11. H. G Houghton; “The size and size distribution of fog particles” Physics, Vol. 2 pp. 467-475 (1932)
12. T. S. Chu and D. C. Hogg The Bell System Technical Journal, (May-June 1968)
13. A. Amulf et al, JOSA 47 pp. 491-498 (1957)
14. See, for example, II-VI application note

### BACKGROUND OF THE INVENTION

Fiber optical networks are rapidly replacing copper cables for high-bandwidth and reliable transmission of information over large distances. Optical communication using fibers have extremely large bandwidths (i.e. high transmission rate, typically tens of gigabits per second). The efficient utilization of fiber optics communication networks requires that all “end users” be connected to the fiber optic network.

US studies, however, indicate that less than 5% of US businesses are connected to the network although more than 75% are within one mile of the fiber backbone [1]. Over this “last mile”, traditional copper cables are used for data transmission and the benefits of the wide bandwidths afforded by optical fibers are lost.

Deployment of fiber directly to all these end customers is costly and time consuming, as this requires the retrenching of urban streets and a license from the authorities. A proposed solution is to transmit the infra-red waves used in optical fiber communications directly over free space to a receiving optical fiber located at the end user's building [2][3]. However, free space communication in the optical range may be adversely affected by prevailing weather conditions, and in particular, optical radiation is obstructed in dense fog conditions. For example, in a fog of 0.1 gm/m³ precipitated water droplets, the one-way attenuation is greater than 200 dB/km, while for the longer sub-millimeter waves, the attenuation is less than 10 dB/km, and for millimeter waves, less than 1 dB/km [4].

As a result of the high attenuation of laser radiation under dense fog conditions, the maximal required laser intensity in the optical range is well beyond practical capabilities [5], and even when available, it may be well beyond eye safety standards allowed for transmitted energy in air. A possible solution to cope with such optical range inherent limitations is to use longer waves (e.g., in the Radio Frequency range) which, as illustrated in the numerical example above, are less susceptible to atmospheric attenuation by fog and are not subject to any eye safety requirements, thus affording the reliable transmission of data through fog. The use of longer wavelengths for free space communication under foggy weather conditions is known (see WO 00/52450 [6]). The latter publication discloses an RF system that is used as a backup in atmospheric conditions (such as fog) which adversely affect transmission rate. This solution has several inherent shortcomings, including:
Size: Since the wavelength of RF is large compared to optical systems, and since point-to-point communication systems require highly directional beams, RF systems tend to be big and cumbersome.
All broad RF bands require licensing. Such licensing is time consuming and therefore the inherent fast deployment advantage of optical systems is lost.
Due to its inherent lower frequency, RF bands have limited bandwidth capability, with no growth potential beyond 1 Gbit/sec.
Unlike in the case of using an additional optical band, in which most of the optical components can be used for both bands, incorporation of an RF system requires the use of completely separate sub-systems and components.

Other communication methods, such as the use of CO₂ lasers at the Far Infrared region, have been considered for use in space applications, mainly for inter-satellite communication at ranges up to 80,000 km [8][9]. In such systems the high power and exceptional directionality of the CO₂ laser beam are used to achieve the desired performance. However, such systems are inadequate for use for space to earth communication, and there is no record in the Prior Art for the use of Far Infrared broadband communication for horizontal, inter-atmospheric or space-to-earth communication.

There is an apparent need in the art to substantially overcome the drawbacks of Prior Art solutions, especially, but not limited, to their ability to operate in high bandwidth in adverse weather conditions.

### SUMMARY OF THE INVENTION

The invention provides for a Far Infrared (FIR) transciever device, which includes a transmitter and a receiver, for communicating data modulated on an electromagnetic signal over free space in the atmosphere, comprising:

The tranmitter that includes:
a laser source configured to generate electromagnetic signal in the far infrared range; and
a modulator for modulating said electromagnetic signal giving rise to modulated data corresponding to high transmission rates; said modulated data is transmitted at said high transmission rates through said free space; and
the receiver that includes a detector for receiving modulated data at said high transmission rates through said free space.

The invention further provides for a system for communicating data modulated on an electromagnetic signal over free space in the atmosphere, comprising:
a FIR transciever device, for communicating data modulated on an electromagnetic signal in the far infrared over free space in the atmosphere;
a Near Infrared (NIR) trasciever for communicating data modulated on an electromagnetic signal in the near infrared over free space in the atmosphere; and
a controller coupled to said FIR transceiver and said NIR transceiver,
   said controller is configured to perform one or more of the following:
(a) selecting a first mode of operation for communicating modulated data in the far infrared range using said FIR device;
(b) selecting a second mode of operation for communicating modulated data in the near infrared range using said NIR device;
(c) selecting a third mode of operation for communicating modulated data in said far infrared range and modulated data in said near infrared range, using both said FIR and NIR devices.

Still further, the invention provides for a method for communicating data modulated on an electromagnetic signal over free space in the atmosphere, comprising:
generating an electromagnetic signal in the far infrared range;
modulating said electromagnetic signal giving rise to modulated data corresponding to high transmission rates;
transmiting said modulated data at said high transmission rates over said free space through the atmosphere; and
receiving a modulated data at said high transmission rates through said free space.

### BRIEF DESCRIPTION OF THE DRAWINGS

The present invention will now be described in more detail with reference to the following non-limiting embodiments, which give a full description, features and advantages of the invention:

FIG. 1 illustrates the basics of prior art communication system;

FIG. 2 illustrates a top-level diagram of the preferred embodiment;

FIG. 3 illustrates a more detailed block diagram and architecture of the preferred embodiment;

FIG. 4 illustrates optical and mechanical structure of the system with reference to its operation;

FIG. 4a illustrates the architecture of NIR transmitter according to another embodiment;

FIG. 5 illustrates an optical layout of the Far Infrared transmitter; and

FIG. 6 illustrates the layout and operation of the modulator.

### DETAILED DESCRIPTION OF PREFERRED EMBODIMENTS

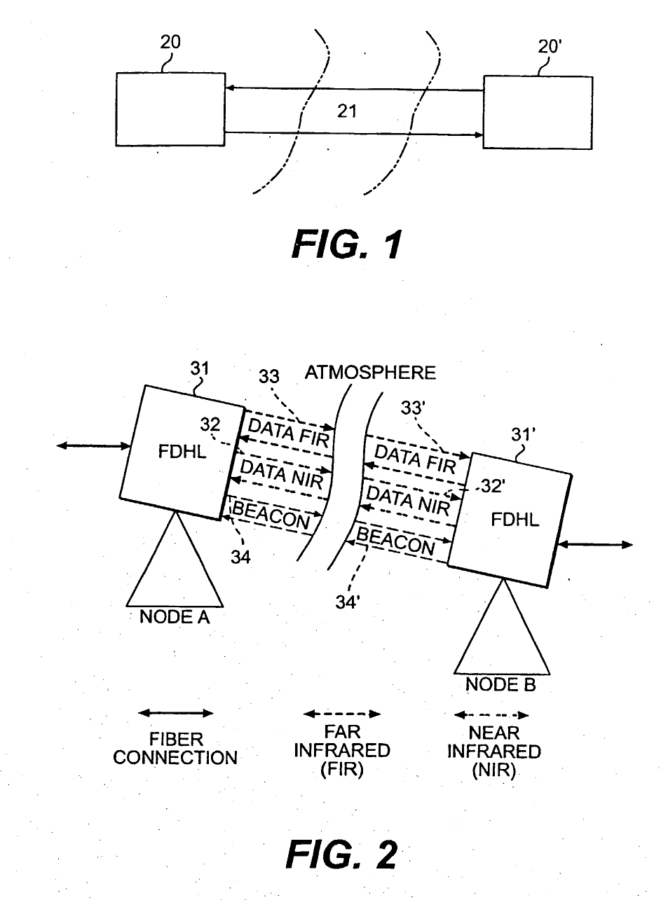

One of the key drawbacks of Prior Art Free Space Optics systems is illustrated in FIG. 1. Devices 20 and 20′ are two identical Prior Art transceivers operating at the Near Infrared (NIR) spectral region (usually, wavelength 7500n to 1550 nm). The atmosphere 21 attenuates the light leaving 20 on its way to 20′ and vice versa, due to absorption and scattering. The attenuation follows the well-known exponential Beer's law: I=I₀exp(−γX), where I₀ is the amount of light emitted from 20, and I is the amount of light reaching 20′. For a visibility range of 100 m (which represent dense fog conditions), I/I₀ will be approximately equal to 0.02 (with some dependence on wavelength) at a distance of 100 m for Near Infrared radiation. Due to the exponential nature of the atmospheric attenuation, for 1 km the attenuation will be 0.02¹⁰=1.024×10⁻¹⁷. It is clear that no available light source will be capable of penetrating such dense fog conditions.

Since the main mechanism of attenuation through fog is governed by light scattering at the water droplet, it can be simulated by using the Mie scattering theory [10]. Sample simulation results are shown in Table 1, for two wavelengths: 1.5 μm (Near Infrared) and 10.6 μm (CO₂ laser wavelength). The results show that for fog with droplets sizes of approximately 1 μm, the 17 orders of magnitude attenuation calculated above can be reduced to less than one order of magnitude. For 2-μm droplet size the attenuation can be reduced to less than 2 orders of magnitude, and for 5-μm to less than 4 orders of magnitude. The advantage of using far infrared wavelength is apparent.

TABLE 1
Fog attenuation at 1.5 μm and 10.6 μm wavelengths at a distance of 1 km
and at a visibility of 100 m

| | Attenuation | |
|---|---|---|
| Droplet diameter (μm) | at 1.5 μm (dB) | Attenuation at 10.6 μm (dB) |
| 1 | 170 | 9.1 |
| 2 | 170 | 17.2 |
| 5 | 170 | 37 |
| 10 | 170 | 86 |
| 20 | 170 | 151 |
| 25 | 170 | 170 |

There is still a need to determine the droplet size in typical types of fog. Although early literature [11] discusses relatively large droplets size of drops—15 to 20 μm, other references [12] indicate that a typical droplet size is less than 1-2 μm. Extensive measurements of natural fog [13] indicate that even for the less transmitting fog, the penetration range at 10.6 μm can be doubled, compared to the case of 1.5 μm.

The advantage of using Far Infrared radiation for Free Space Communication is, therefore, clear.

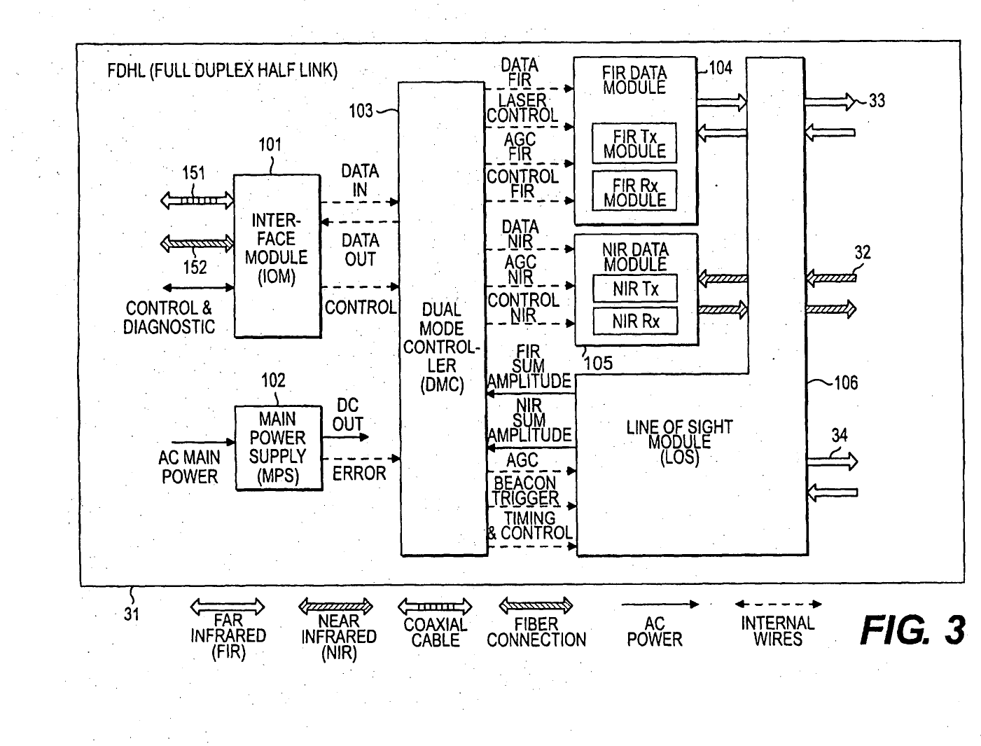

FIG. 2 illustrates a general view of the preferred embodiment. Two identical FDKL (Full Duplex Half Link) transceivers 31 and 31′ are communicating through free space by transmitting and receiving data modulated either over a Near Infrared Radiation 32 and 32′, or over a Far Infrared radiation 33 and 33′, or over both. Also shown in FIG. 2 are the Beacon signals 34 and 34′. These radiated signals (both in Near Infrared—NIR and Far Infrared—FIR) can be used. These signals are used for active alignment of the two transceivers Line of Sights by the use of a tracking system described below.

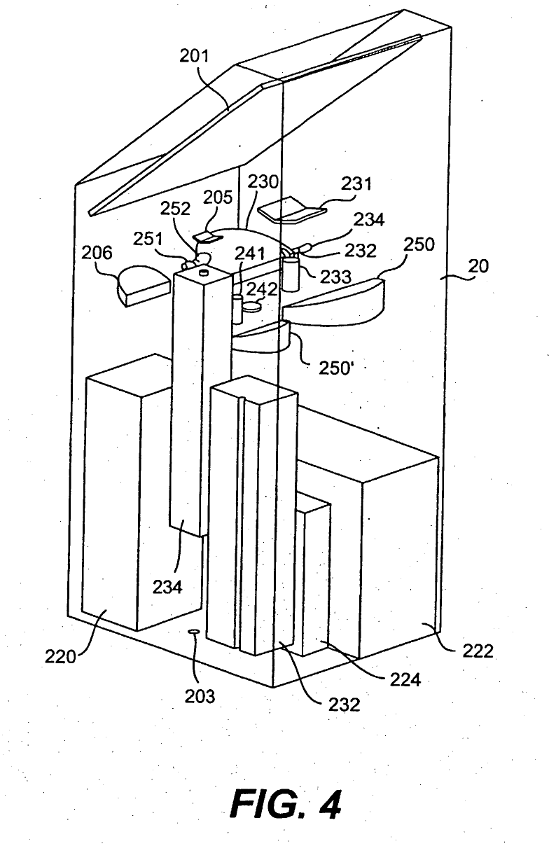

The operation of a single FDHL can be better understood with the help of FIG. 3.

Data is transmitted to and received from the user communication system through either an Optical Fiber 152 or a coaxial cable 151. The data is arranged and prepared by the Interface Module IOM 101 and sent to the Dual Mode Controller DMC 103. The DMC has the following functions:

1. It decides which one of the two transceivers, 104 (FIR) and 105 (NIR), is active. Three modes of operation are available: FIR, NIR, and BOTH. The decision is made based upon the prevailing weather conditions and/or the received signal intensity.

2. In the “BOTH” mode the DMC decides which data is transmitted back to the (IOM) 101. Possible modes are FIR, NIR and COMBINATION. In COMBINATION one of several alternative logics is used to build the most reliable data stream based on the separate NIR and FIR data streams.

3. The DMC also decides which one of the two beacon signals 34 (NIR or FIR) is active, both for transmission and reception. For simplicity only one signal 34 is shown, and it represents both NIR and FIR signals. Three modes of operation are available: FIR, NIR, and BOTH. The decision, as in the transceiver case, is made based upon the prevailing weather conditions and/or the received signal intensity.

The Line of Sight module (LOS) 106 contains a motorized mirror and two lines of sight sensing mechanism (NIR and FIR), which by means of a closed loop system keeps the line of sight of FDHL 31 with that of FDHL 31′.

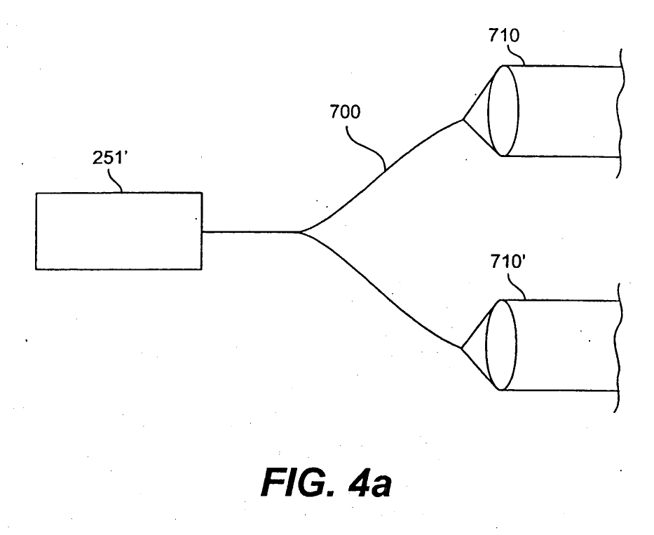

The preferred embodiment of the FDHL is further shown in FIG. 4. Mirror 201 receives and transmits the optical signals: FIR, NIR and Beacon (NR and FIR). The Line of Sight of the Mirror is controlled by two motors (not shown) to keep the LOS aligned with FDHL 31′.

The receiver part of the FDHL operates as follows:

The FIR signal is received by off-axis parabolic mirrors 230 and 230′, which direct the light onto split mirror 231, onto Infrared light detector 233. A single element QWIP detector (not shown here) is used in the present embodiment to enable data bandwidth above 1 Gbit per second.

The NIR received signal also follows the path of the two off-axis parabolic mirrors 230 and 230′ and split mirror 231. Dichroic Beam splitter 232 directs the NIR light onto NIR detector 234.

The FIR transmitter portion of the FDHL operates as follows:

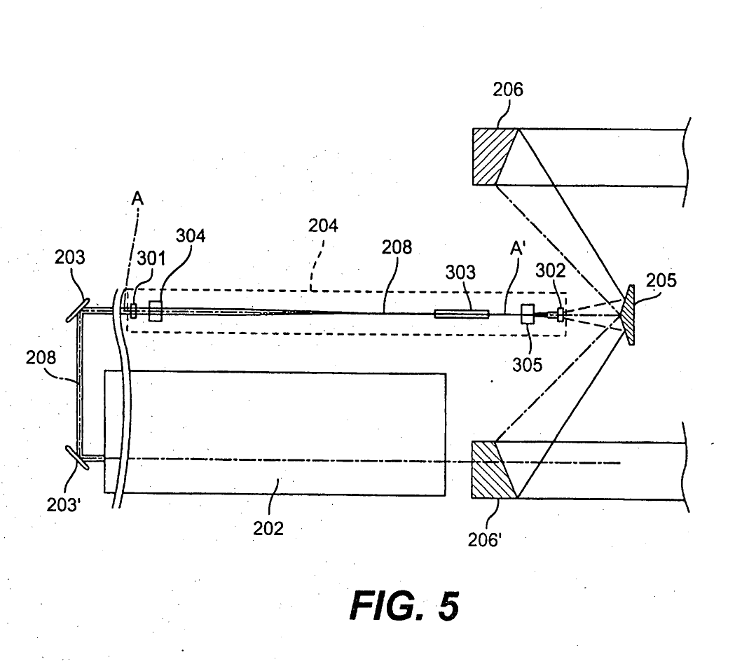

CO₂ laser 202 emits Infrared radiation at preferably 10.6 μm. The output power at the preferred embodiment is e.g. 10 Watt of CW radiation, but higher laser power can be used. The laser radiation is folded by the use of two mirrors—only the second one, 203, is shown—while the first one, 203′, which will be discussed below, is shown in FIG. 5. These two mirrors direct the laser light onto the Modulator assembly 204. The modulator assembly modulates the laser light according to the data received from DMC 203, and emits a modulated laser light. The modulated laser light goes through a NW/FIR beam splitter 252, the FIR transmitting split mirror 205, the NIR/FIR transmitter off axis parabolic mirrors 206 and 206′, and mirror 201, where the latter transmits the light to FDHL 31′.

The NIR transmitter portion of the FDHL operates as follows:

NIR light source 251 emits NIR modulated light. This light is reflected by NIR/FIR beam splitter 252 and follows the same path as the FIR signal: split mirror 205, off-axis parabolic mirrors 206 and 206′, and mirror 201.

An alternative embodiment for splitting the NIR transmitter aperture is described in FIG. 4a. The NIR light source 251′ transmits the modulated light into a bifurcated optical fiber 700, which is transmitted through the pair of lenses 710 and 710′ onto mirror 201.

The NIR portion of the beacon operates as follows:

The NIR beacon light source 241 transmits NIR light through mirror 201 to FDHL 31′. The light received from a similar beacon of FDHL 31′ is reflected by mirror 201 onto the detector optics 242. The detector optics directs the light received from the beacon of FDHL 31′ onto a 4-quadrant detector (not shown). The signal from the 4-quadrant detector signal is analyzed in the electronics box 220 and sends the correction signal to the mirror motors.

Also there are a FIR beacon that uses a portion of the light of laser 202, and a 4-quadrant FIR detector. These elements are not shown in FIG. 4. The portion of laser light used in the preferred embodiment is extracted prior to the modulator assembly 204. This enables the use of a non-modulated light and a more efficient use of the available laser energy.

Also, to enable recovery from possible track loss, an angular positioning sensor (not shown) is used. In the preferred embodiment, a combination of a magnetic sensor and a gravitation sensor is used. Alternative embodiments are also known to those skilled in the art, such as acceleration-based sensor or an inertial sensor.

It is important to emphasize the role of using split apertures both for transmitting and receiving the light. This makes the communication link much more immune to temporal obstruction, which may block the optical link, such as birds and plastic bags.

Other elements shown in FIG. 4 are the Modulator Power Supply 222, the laser power supply 221, and the electronics box 220.

The details of the FIR transmitter are further explained with the use of FIG. 5. FIG. 5 shows a cross-section of the optical path shown in FIG. 4, and in addition it shows folding mirror 203′, which was not shown in FIG. 4 and the optical details of the Modulator Assembly 204.

In the preferred embodiment Laser beam 208 is linearly polarized in the drawing plane, although polarization in a plane perpendicular to the drawing plane is also possible. The polarized beam goes through a focusing lens 301, a quarter wave plate 304, the modulator 303, and the analyzer 305. Lens 302 is used to diverge the beam onto split mirror 205 and further to the off-axis parabolic mirrors 206 and 206′, which generate a highly collimated beam, as explained above.

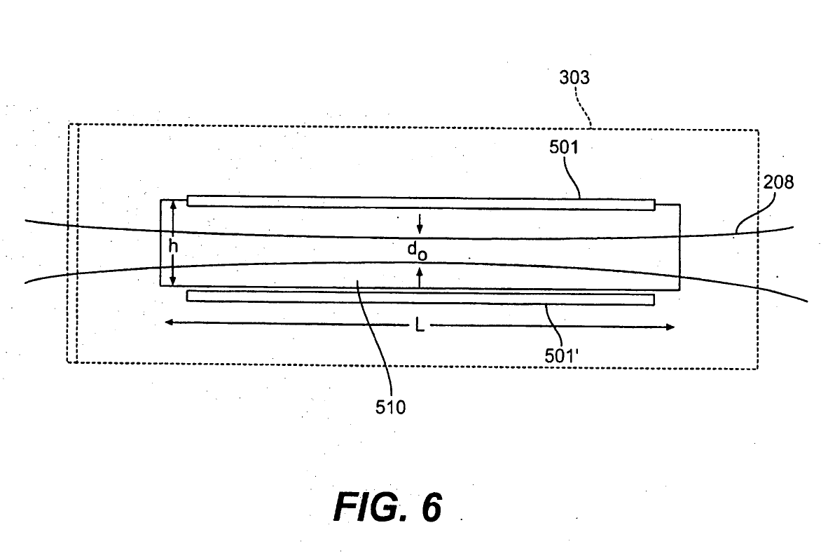

The details of the operation of the modulator will now be explained with the help of FIGS. 5 and 6.

FIG. 6 shows the details of modulator 303. The modulator consists of a crystal, preferably made of CdTe, two electrodes 501 and 501′, and housing (not shown). When a voltage V is applied between the two electrodes 501 and 501′, the crystal changes the state of polarization of the laser beam 208. In the preferred embodiment a quarter waveplate 304 is used to convert the laser linear polarization into a circular polarization at the input of the modulator. This enables operation of the crystal at its linear zone for higher modulation efficiency, as explained below.

Analyzer 305 is a linear polarizer, which converts the light emitted from the modulator back into a linearly polarized light, thus converting the change in polarization state induced by the crystal into an intensity modulation.

For this configuration it can be shown that the transmission T (defined as the ratio of intensities at points A′ and A in FIG. 5) is given by:

$$T = {sin}^{2} [ \frac{π}{2} ( \frac{1}{2} + \frac{V}{{V}_{λ / 2}} ) ] \qquad ( 1 )$$

where V_{λ/2} is the half-wave voltage. It can be easily seen that T=0 for V=−½V_{λ/2} and 1 for V=½V_{λ/2}. If a voltage of ΔV (typically smaller than V_{λ/2}) is applied, the change in transmission ΔT is given by:

$$Δ T = sin ( \frac{π}{2} \frac{Δ V}{{V}_{λ / 2}} ) \qquad ( 2 )$$

Which enables operation of the modulator at the linear zone for better efficiency, as explained above.

The half-wave voltage for a CdTe crystal is given by: V_{λ/2}=53 kV·h/L, where h and L are the crystal height and length, respectively, as shown in FIG. 6. It is clear that the ratio of h/L should be as small as possible to achieve high modulation efficiency. In the preferred embodiment h=2 mm, and L=50 mm. For these parameters V_{λ/2}=2120 V.

Since it's hard to drive such voltages at high (1 Ghz) rates, a typical value in the preferred embodiment is ±40V Under these conditions we get a modulation depth (namely the change in transmission divided by the average transmission) of 12%.

Lens 301 is designed to focus the laser beam in the crystal so that its waist diameter (1/e²) is approximately 2/3 of the crystal height, for optimal insertion losses. For this beam waist diameter, the beam within the crystal is substantially parallel.

The present invention has been described with a certain degree of particularity. Those versed in the art will readily appreciate that various alterations and modifications may be carried out without departing from the scope of the following claims:

1. A Far Infrared (FIR) transciever device, which includes a transmitter and a receiver, for communicating data modulated on an electromagnetic signal over free space in the atmosphere, comprising:
The tranmitter that includes:
a laser source configured to generate electromagnetic signal in the far infrared range; and
a modulator for modulating said electromagnetic signal giving rise to modulated data corresponding to high transmission rates; said modulated data is transmitted at said high transmission rates through said free space; and
the receiver that includes a detector for receiving modulated data at said high transmission rates through said free space.

2. The device according to claim 1, wherein said laser source being a CO₂ laser.

3. The device according to claim 1, wherein said laser source is configured to generate said electromagnetic signal at a wavelength of 10.6 μm.

4. The device according to claim 1, wherein said tranmission rate is in the Gbit per second region or above.

5. The device according to claim 1, wherein said modulaor is constrcuted of a crystal made of CdTe.

6. The device according to claim 1, wherein said receiver includes a QWIP detector operating at said high transmission rate.

7. The device according to claim 6, wherin the QWIP detector has a single element.

8. A system for communicating data modulated on an electromagnetic signal over free space in the atmosphere, comprising:
a FIR transciever device, for communicating data modulated on an electromagnetic signal in the far infrared over free space in the atmosphere;
a Near Infrared (NIR) trasciever for communicating data modulated on an electromagnetic signal in the near infrared over free space in the atmosphere; and
a controller coupled to said FIR transceiver and said NIR transceiver,
said controller is configured to perform one or more of the following:
(a) selecting a first mode of operation for communicating modulated data in the far infrared range using said FIR device;
(b) selecting a second mode of operation for communicating modulated data in the near infrared range using said NIR device;
(c) selecting a third mode of operation for communicating modulated data in said far infrared range and modulated data in said near infrared range, using both said FIR and NIR devices.

9. The FIR transciever device according to claim 8, which includes a transmitter and a receiver, for communicating data modulated on an electromagnetic signal over free space in the atmosphere, the device comprising:
the tranmitter that includes:
a laser source configured to generate electromagnetic signal in the far infrared range; and
a modulator for modulating said electromagnetic signal giving rise to modulated data corresponding to high transmission rates; said modulated data is transmitted at said high transmission rates through said free space; and
the receiver that includesa detector for receiving modulated data at said high transmission rates through said free space.

10. The system according to claim 8, wherein said controller operating in any of said modes of operation, depending upon prevailing weather conditions.

11. The system according to claims 8, wherein said controller operating in any of said modes of operation according to the intensity of the received modulated data.

12. A system that includes a first FIR transciever as defined in claim 1 and a second FIR transciever as defined in claim 1; the transmitter of said first FIR transciever transmits data modulated on an electromagnetic signal over free space in the atmosphere to a receiver of said second transciever; the transmitter of said second transciever transmits data modulated on an electromagnetic signal over free space in the atmosphere to the receiver of said first transciever.

13. A method for communicating data modulated on an electromagnetic signal over free space in the atmosphere, comprising:
generating an electromagnetic signal in the far infrared range;
modulating said electromagnetic signal giving rise to modulated data corresponding to high transmission rates;
transmiting said modulated data at said high transmission rates over said free space through the atmosphere; and
receiving a modulated data at said high transmission rates through said free space.

14. The method according to claim 13, wherein said electromagnetic signal is at a wavelength of 10.6 μm.

15. The method according to claim 13, wherein said transmission rate is in the Gbit per second region or above.
